(19) United States
(12) Patent Application Publication
(10) Pub. No.: US 2016/0174737 A1
(43) Pub. Date: Jun. 23, 2016

(54) System and Method for Hanging a Frame on a Wall

(71) Applicant: Anthony Lehrman, Gilbert, AZ (US)

(72) Inventor: Anthony Lehrman, Gilbert, AZ (US)

(21) Appl. No.: 14/552,864

(22) Filed: Dec. 18, 2014

(51) Int. Cl. A47G 1/16; B25C 3/00

(52) U.S. Cl. CPC A47G 1/16; B25C 3/006

(57) ABSTRACT

Disclosed herein is a system for hanging frames on a wall. The system includes an insertion tool and at least one insertion member. The insertion tool has a handle portion and a working portion. Each insertion member has a first and a second end and each end is capable of piercing into the frame or a wall. Each insertion member has a center member defining a stop for preventing over-insertion of the insertion member into the wall or the frame. And, insertion member adapted for removable connection with the working portion of the insertion tool. Also, disclosed herein is method of using the system herein to hang the frame on the wall easily and removably.

### BACKGROUND OF THE INVENTION

1. Field of the Invention

This invention relates to the field of home improvement products. More particularly, the disclosure herein, relates to self-home improvement products that include hanging picture frames and the like on a wall.

2. Background

There may be no more common sight in a home than a hanging picture frame. Whether you're rich or poor, married or single, young or old, it seems everyone has at least one picture frame on one of their walls of their home and/or office. Of course, what's in the frame varies as widely as there are different types of people. In fact, it is rare to see the same type of pictures in two different people's homes. But, the fact is, virtually everyone has picture frames hanging from their walls.

It would seem a simple thing to hang a picture frame on a wall. But, as anyone who has tried knows, what seems simple at first can become a mighty project before it's done correctly. In fact, many people give up in disgust and frustration and instead of a self-home improvement project, it becomes a somewhat costly nightmare, resulting in having to hire and supervise a person talented enough in this field to get the job done properly. Like most things, however, just because a hired person may be talented at hanging pictures, doesn't mean they understand how and where you want your pictures hung. Nor does it mean the hired person understands how to follow directions.

Additionally, even assuming one is or finds a talented person capable of following directions, there are always those in a household that will change their mind about where certain picture frames should be placed or in many cases, replaced. That means very likely, starting the process of trying to hang the frame yourself, failing, finding a talented person and then hanging the picture frame and repeating the process several times. It may well include the additional step of repairing holes in the walls left by previous, misguided attempts to hang the picture frame.

What is needed is a simple and economical what to hang picture frames without requiring the installer, e.g. ordinary resident of a household, to possess any particular skills to hang a frame straight on a wall. An additional long-felt need is the ability to remove and re-hang a picture frame in a separate location without creating damage that needs to be repaired each time a frame is moved. Consistent with this long-felt need, Applicant herein has created a new system and method for hanging a picture frame on a wall.

### SUMMARY OF THE INVENTION

Applicant has disclosed herein a unique new system and method for hanging a picture frame on a wall. In the system created by Applicant, there is included a tool and at least one insertion member. The insertion member in an exemplary embodiment resembles a two-pointed nail. The tool is comprised of two parts. In the first part, the tool defines a handle portion and in the second part, the tool has a working portion. The working portion has a length-wise opening. In the case, where there is more than one insertion member, each of the insertion members is identical to one another and each is adapted to fit, one end within the opening and the other end protruding out of the opening. The insertion member has a center member defining a stop located about half-way down the length of the insertion member. The center member has a diameter greater than the diameter of the opening and thus serves to prevent more than half of the insertion member from being within the opening at any time in an exemplary embodiment.

In an exemplary embodiment, each of the ends of the insertion member has been sharpened to facilitate insertion into the frame and into the wall. Sharpened insertion member may be removed from a wall more easily and are less likely to cause wall damage or frame damage upon removal.

In an exemplary embodiment, each of the insertion members is identical and symmetrical. And additionally, the center member is precisely half-way between the ends. In another exemplary embodiment, the center member is located more toward one end than the other.

In an exemplary embodiment of the method of hanging a picture frame, the steps include, providing a system for hanging a frame on a wall. The system includes an insertion tool and at least one insertion member of the kind described above with respective to the apparatus of the invention.

Next, an insertion member is inserted into the insertion tool in the opening provided in the insertion tool working end. Once inserted into the tool, the insertion member is aligned at a right angle to the horizontal plane of the frame and inserted into the frame by tapping the top surface of the insertion tool until the center member stops further progress.

The combination of frame with insertion members is then aligned at right angles to the wall. The wall has a vertical plane and the insertion member lies in a horizontal plane. The insertion members are aligned so that the horizontal plane is at right angles to the vertical plane of the wall.

In the case where the frame has corners, such as a rectangular frame or a square frame, the insertion members are in the top corners of the hung frame and the free end projects toward the wall. The sides of the frame are balanced so that they both lie in the same vertical plane, parallel to the vertical plane of the wall. Once alignment is achieved, the combination of the frame with the outwardly projecting insertion members, are in the aligned position. At that point, the frame is pressed into the wall in the spot on the wall desired.

Thus, the system and method disclosed herein gives the household resident the optimum possibility of keeping the project a self-improvement project.

### BRIEF DESCRIPTION OF THE DRAWING

For a further understanding of the objects and advantages of the present invention, reference should be had to the following detailed description, taken in conjunction with the accompanying drawing, in which like parts are given like reference numerals and wherein:

FIG. 1 is a perspective illustration of the insertion tool used in accordance with the disclosure herein.

FIG. 2 is a cross sectional view of the he tool used in accordance with the disclosure herein taken along line 2-2 of FIG. 1.

FIG. 3 is a perspective illustration of the insertion members used in accordance with the disclosure herein.

FIG. 4 is a perspective illustration of the insertion members inserted into the insertion tool in accordance with the disclosure herein.

FIG. 5 is a perspective illustration of the insertion member in accordance with the disclosure herein being inserted into the frame.

### DETAILED DESCRIPTION OF THE SYSTEM & METHOD FOR HANG A FRAME ON A WALL

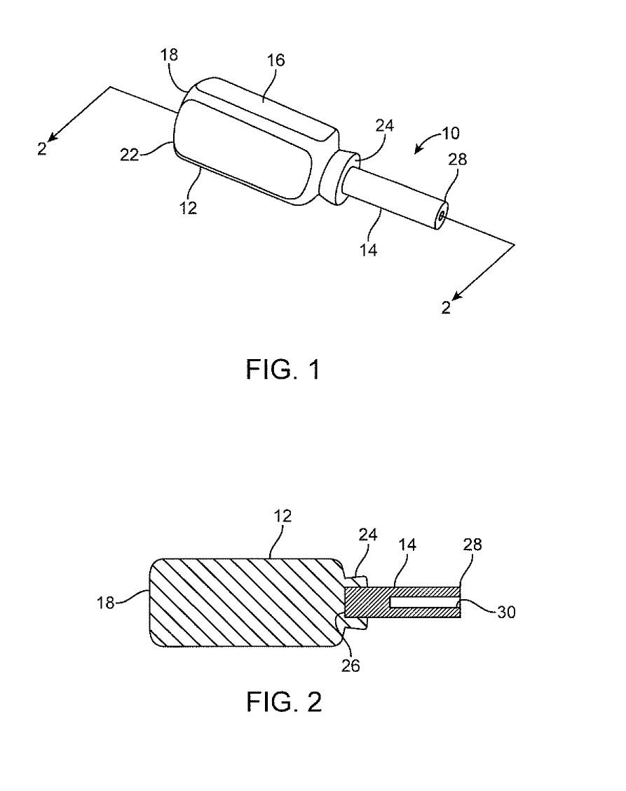

The invention will now be described with respect to FIGS. 1-5, which illustrate the system and method of hanging a frame in accordance with the disclosure by Applicant herein. The system, which comprises the apparatus portion herein, includes two main elements, an insertion tool, shown generally by the numeral 10 and insertion members shown generally by the numeral 20.

With particular reference to FIG. 1, there is shown, in perspective, a three-dimensional view, of the insertion tool 10. The insertion tool 10 includes a handle portion 12 and a working portion 14. The handle portion 12 is adapted for facilitating gripping. To that end, the handle end in the exemplary embodiment is shaped as a screw driver handle. For example, the handle portion 12 has flat surfaces 16, which are specifically designed to enhance the user's grip. Additionally, in an exemplary embodiment, the handle flat surfaces 16 are padded with a neoprene material for soft and yet firm gripping by the user. Such neoprene surfaces are non-slip and facilitate even those with less powerful grips, to be able to accomplish the purposes and objectives of the disclosure herein.

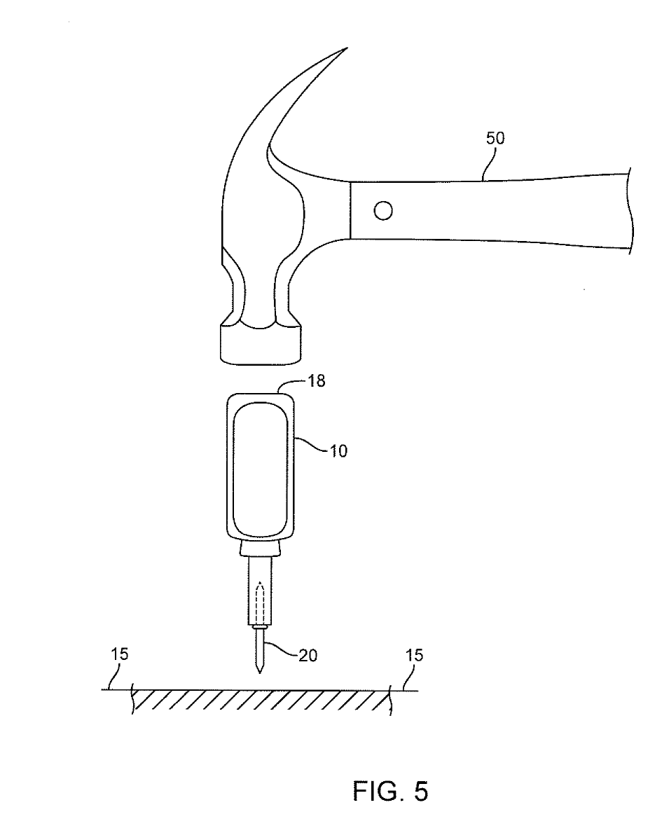

Additionally, the handle portion 12 also includes a top surface 18. The handle portion 12 has a proximal end 22 and a distal end 24. As particularly well illustrated in FIG. 5, the proximal end 22 has a top surface 18. The top surface 18 is specifically designed for hammering. It will be appreciated by those skilled in the relevant art that hammering herein is not of the kind that one would expect for example, when building a house, but rather fine hammering with a light touch so as to only accomplish the purposes and objectives of the invention without causing damage to the frame.

The working portion 14, as clearly shown in FIGS. 1 & 2, has a proximal end 26 and a distal end 28. The proximal end 26 is attached to the distal end 24 of the handle portion 12. As particularly well illustrated in cross section, FIG. 2, in the exemplary embodiment therein, the working portion 14 is attached to the handle portion 12 within the confines of the distal end 24 of the handle portion 12. Such attachment is within the skill and design of those previous structures like a screw drivers and such is not considered novel or an important aspect of this invention.

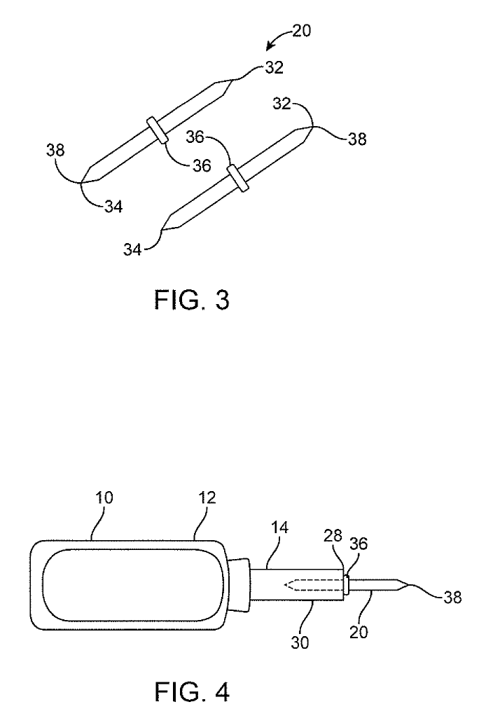

The working portion 14 distal end 28 has an opening 30 extending part way the length of the working portion 14. The opening 28 is adapted to accommodate each of the insertion members 20 as will be clear upon reference to FIGS. 3 and 4. In the exemplary embodiment, the opening 28 is rectangular in cross-section as shown in FIG. 2. The opening 30, in the exemplary embodiment, extends about two-thirds of the way from the distal end 28 to the proximal end 26.

The cross-sectional view of FIG. 2 shows the diameter of the opening 28 and as noted above the opening 28 is adapted so that a user inserts the insertion member 20 into the opening 28 in a secure manner. Thus, the opening 28 is sized and shaped to provide a friction fit between the opening 28 and the members 20. The friction fit is strong enough so that when the insertion tool 10 is turned upside down with gravity urging disconnection between the insertion member 20 and the insertion tool 10, the member 20 remains in place.

With particular reference to FIG. 3, there is shown a pair of insertion members 20. Each insertion member 20 has opposed ends 32 and 34 and a center member 36 half-way between the opposed ends 32 and 34. The center member 36, in the exemplary embodiment of FIG. 3, defines a ring-like member.

The center ring-like member 36 has a diameter greater than the diameter of the insertion member 20 and appears as a ring extending from the outer surface of the member 20. Each side of the center ring-like member 36 defines an abutment surface.

As clearly shown in FIG. 4, as the insertion member 20 is inserted into the opening 30, the center ring-like member 36 approaches the distal end 28 of the working portion 14 of the handle 10. Upon engaging the distal end 28 with the center member 36, the insertion member 20 stops moving toward the proximal end 26. Thus, the center member 36 defines and functions as a stop preventing further movement into the opening 30.

The opening 30 and the insertion members 20 are cooperatively designed to work together. The length of the opening 30 is longer than the length of the insertion member from the center member 36 to the end of the insertion member.

As illustrated in FIGS. 3 and 4, the exemplary embodiment of the insertion member 20 is symmetrical. Each of the ends 32 and 34 is identical. Each of ends 32 and 34 has a piercing point 38. The point 38 has been sharpened to facilitate piercing of both the frame and the wall. In effect, the insertion member 20 defines a 2-pointed nail.

Typically, the frame to be hung on the wall is constructed of wood, or at least a pierceable material. By pierceable, it is meant pierceable through the surface of the material without undue force. Quite clearly the system of hanging a frame on a wall disclosed herein does not apply to non-pierceable frames or non-pierceable walls. For example under ordinary circumstances solid metal walls or solid metal frames would not be good candidates for the system in accordance with this disclosure.

In the exemplary embodiment shown in FIG. 4, the insertion tool 10 is illustrated with the handle portion 12 and the working 14 having an insertion member 20 within the opening 30. The insertion member 20 is adapted for slideable insertion into the opening 30. In different exemplary embodiments, where the opening 30 has a different size, the insertion member 20 is adapted for slideable fit within that opening.

Additionally, the insertion member 20 is adapted so that there is a friction fit between the insertion member 20 and the opening 30. The friction fit is tight enough so that when the insertion tool 10 is turned to encourage gravity to urge the insertion member 20 out of the opening 30, the insertion member 20 stays in place and does not move within the opening 30. And, of course, without additional and external forces applied to either the insertion member 20 or the insertion tool 10, the insertion member 20 remains within the opening 30.

However, the friction fit of the insertion member 20 with the opening 30 is not so great as to require extraordinary force or external implements to remove the insertion member 20. Additionally, the ordinary friction strength of a nail into a wood frame is sufficient to remove the insertion member 20 from the opening 30.

In the exemplary embodiment of the method of the invention, the insertion member 20 is inserted into opening 30 as illustrated in FIG. 4. FIG. 5 illustrates another step in the method of the exemplary embodiment of the system for hanging a frame on the wall. FIG. 5 illustrates the step of inserting the insertion member 20 into a frame for hanging on the wall.

An external implement, in this case, a hammer 50 taps against the handle end 12 of the insertion tool 10. Specifically, the hammer 50 taps against the top surface 18 until the insertion member 20 is firmly in place. The frame 13 has a horizontal plane 15-15. In order to achieve optimal results and hanging a straight frame on the wall, the insertion member 20 is inserted perpendicular to the horizontal plane 15-15.

Upon proper insertion the insertion member 20 will be at right angles to the horizontal plane 15-15. Once that is achieved the frame 13 is aligned with the wall, making sure that the insertion members 20 are perpendicular to the wall and that the top of the frame has a plane which lies parallel to the horizon.

Upon achieving the proper angle, the frame is merely pressed into the wall. Since the insertion member 20 have been sharpened and the wall is pierceable it is a simple matter to hang the frame 13 perfectly on the wall.

In an exemplary embodiment of the method of hanging a frame 13, the steps include, providing a system 10 for hanging a frame on a wall. The system includes the insertion tool 10 and at least one insertion member 20 of the kind described above. Next, an insertion member 20 is inserted into the insertion tool 10 in the opening 30 provided in the insertion tool working end 14. Once inserted into the tool 10, the insertion member 20 is aligned at a right angle to the horizontal plane of the frame 13 and inserted into the frame 13 by tapping the top surface of the insertion tool 10 until the center member 36 stops further progress. The combination of frame 13 with insertion members 20 is then aligned at right angles to the wall. In the case where the frame 13 has corners, such as a rectangular frame or a square frame, the insertion members 20 are in the top corners of the hung frame and the free end of the insertion members 20 projects toward the wall. The wall has a vertical plane and the insertion member 20 lies in a horizontal plane. The insertion members 20 are aligned so that the horizontal plane is at right angles to the vertical plane of the wall. The sides of the frame are balanced so that they both lie in the same vertical plane, parallel to the vertical plane of the wall. Once alignment is achieved, the combination of the frame with the outwardly projecting insertion members 20 are aligned and the frame is pressed into the wall in the spot on the wall desired.

In some cases, the frame will have no corners. For example, the frame may be circular or oval in shape. In cases where the frame is light, a single insertion member 20 is all that is necessary. The top of the apex of the frame is found and the insertion member 20 is inserted in the frame at that point. This is true for both oval and circular frames.

In the case where the frame is too heavy for one insertion member, two insertion members are used. In this case, an arc outlining the top half of the is drawn and bisected. In an exemplary, the insertion members are placed 5 degrees from the apex or bisection point. In other exemplary embodiments, the insertion members 20 are placed 6 degrees from the apex. The insertion members 20 are placed 7 degrees from the apex. And, so on. Thus, there are virtually limitless number of possible exemplary embodiments within the spirit and scope of the disclosure herein.

While the foregoing detailed description has described several embodiments of the system and method of hanging a frame on a wall in accordance with this disclosure, it is to be understood that the above description is illustrative only and not limiting of the disclosed invention. Particularly, various types and size and shapes of insertion members may be used depending upon the frame and wall used in any particular application. Additional, and other variations are noted above and will be readily understood by those skilled in the art. It will be appreciated that the embodiments discussed above and the virtually infinite embodiments that are not mentioned could easily be within the scope and spirit of this invention. Thus, the invention is to be limited only by the claims as set forth below.

1. A system for hanging frames on a wall, the system comprising:
an insertion tool, the insertion tool having a handle portion and a working portion; and
a plurality of insertion members;
each insertion member having first and second ends, each end capable of piercing into the frame to be hung;
each insertion member capable of piercing into the wall where the frame is to be hung;
each insertion member having a center member defining a stop for preventing over insertion of the insertion member into the wall or the frame; and
each insertion member adapted for removable connection with the working portion of the insertion tool.

2. A system for hanging frames on a wall, as set forth in claim 1, wherein the handle portion of the insertion tool includes a surface for conducive for encouraging grip.

3. A system for hanging frames on a wall, as set forth in claim 1, wherein defines a frame having corners and wherein, the insertion members are inserted at the corners which will be on top of the frame when the frame is hung.

4. A system for hanging frames on a wall, as set forth in claim 1, wherein at least two insertion members are used.

5. A system for hanging frames on a wall, as set forth in claim 1, wherein the handle working portion has an inside opening and wherein the insertion member fits snugly within the opening and wherein the center member acts as a stop against opening.

6. A system for hanging frames on a wall, as set forth in claim 5, wherein the center member defines a ring having a diameter larger than the diameter of the opening of the working portion.

7. A system for hanging frames on a wall, as set forth in claim 6, wherein the insertion member defines a two-pointed nail-like member and including the center member half-way between the two ends.

8. A system for hanging a frame on a wall, as set forth in claim 7, wherein each of the insertion member heads includes ends sharpened to facilitate piercing of the frame and the wall with relative ease.

9. A system for hanging a frame on a wall, as set forth in claim 1, wherein the handle portion of the insertion tool has a proximal end farther away from the working portion and a distal end adjoining the working portion and wherein the proximal end provides a suitable surface for hammering.

10. A system for hanging a frame on a wall, as set forth in claim 1, wherein the Insertion members are identical to one another.

11. A system for hanging a frame on a wall, as set forth in claim 10, wherein the Insertion members are symmetrical.

12. A system for hanging a frame on a wall, as set forth in claim 10, wherein the Insertion members are non-symmetrical.

13. A system for hanging a frame on a wall, as set forth in claim 1, wherein the Insertion members are friction fit within the working portion opening.

14. A method of hanging a frame on a wall, comprising the steps of
providing a system for hanging a frame on a wall, including an insertion tool and at least one insertion member;
inserting the insertion member into the insertion tool;
aligning the insertion member to the frame using the insertion tool;
inserting the insertion member into the frame using the insertion tool; and
inserting the combination of the frame with the insertion member into the surface of the wall.

15. The method of hanging a frame on a wall, as set forth in claim 11, which includes the step of inserting the combination of the frame with the insertion member into the surface of the wall by pushing the frame with the insertion member against the wall thereby piercing the surface of the wall.

16. The method of hanging a frame on a wall, as set forth in claim 12, wherein the aligning step includes finding the vertical plane of the frame; inserting the insertion member into the frame at a perpendicular angle to the vertical plane of the frame.

17. The method of hanging a frame on a wall, as set forth in claim 13, wherein the method includes the step of aligning the combination of the frame with the insertion member to the wall before inserting the combination of the frame with the insertion member into the surface of the wall.

18. The method of hanging a frame on a wall, as set forth in claim 14, wherein the method includes the step of finding the vertical plane of the wall before aligning the combination of the frame with the insertion member to the wall and inserting the insertion the combination with the insertion members at a perpendicular angle to the vertical plane.
